(19) United States
(12) Patent Application Publication
(10) Pub. No.: US 2014/0165525 A1
(43) Pub. Date: Jun. 19, 2014

(54) MOTOR DRIVE DEVICE AND ELECTRIC MOWING MACHINE

(71) Applicant: MAKITA CORPORATION, Anjo-shi (JP)

(72) Inventor: Chisako NAGATA, Anjo-shi (JP)

(73) Assignee: MAKITA CORPORATION, Anjo-shi (JP)

(21) Appl. No.: 14/097,823

(22) Filed: Dec. 5, 2013

(30) Foreign Application Priority Data
Dec. 19, 2012 (JP) 2012-277120

(51) Int. Cl. A01D 34/00

(52) U.S. Cl. CPC A01D 34/006
USPC 56/11.2

(57) ABSTRACT

A motor drive device according to one aspect of the present invention includes an operation switch, a control unit, an adjusting unit, and a normal/reverse changeover switch. The control unit is configured, in a case where the operation switch is in an on state, to control a current flowing to the motor based on a control target value adjusted by the adjusting unit when a rotational direction of a motor is set to a normal direction by the normal/reverse changeover switch; and to control the current flowing to the motor based on a preset fixed reverse rotation control target value used to reversely rotate the motor, regardless of the control target value set by the adjusting unit, when the rotational direction is set to a reverse direction by the normal/reverse changeover switch.

### CROSS-REFERENCE TO RELATED APPLICATIONS

This application claims the benefit of Japanese Patent Application No. 2012-277120 filed Dec. 19, 2012 in the Japan Patent Office, the disclosures of which are incorporated herein by reference.

### BACKGROUND

The present invention relates to a motor-driven appliance operated by a motor.

A mowing machine is known that includes a motor driven by a direct current (DC) power source and is configured such that a mowing blade is rotationally driven by the motor. As an example of such a mowing machine, Japanese Unexamined Utility Model Application Publication No. H04-097524, for example, discloses a mowing machine configured such that a rotational direction of a motor (and thus a rotational direction of a mowing blade) can be switched to either of a normal direction, which is a rotational direction for mowing, and a reverse direction, which is a rotational direction for removing grass entangled with the mowing blade.

The above-described mowing machine includes a switching unit and is configured such that the rotational direction can be switched by switching directions of a current flowing from a DC power source to the motor by means of the switching unit.

### SUMMARY

However, in the configuration in which the rotational direction is switched by merely switching the direction of the current flowing to the motor, a number of revolutions at the time of normal rotation and a number of revolutions at the time of reverse rotation are the same as each other. As a result, various problems arise, especially at the time of reverse rotation. For example, since at the time of reverse rotation, it is only necessary to rotate the mowing blade at a minimum number of revolutions required for removing entangled grass, when high revolution similar to that at the time of normal rotation is performed also at the time of reverse rotation, electric power is wasted.

A mowing machine is also known that is configured such that, when a user performs a pull (press) operation of a trigger switch, a mowing blade is rotated at a number of revolutions corresponding to a pull amount of the trigger switch. In the thus-configured mowing machine, it is tolerably possible to eliminate waste of electric power if the user somewhat reduces the pull amount of the trigger switch at the time of reverse rotation, to thereby perform a low-speed rotation. However, in the case of the thus-configured mowing machine, depending on a state of operation by the user, there is still a possibility that the number of revolutions is too high, or in contrast, a possibility that the number of revolutions is too low, to successfully remove grass entangled with the mowing blade.

In one aspect of the present invention, it is preferable that a motor can be reversely rotated effectively in a motor-driven appliance while reducing unnecessary power consumption.

One aspect of the present invention is a motor drive device configured to be provided to a motor-driven appliance including a motor and an electric power source that is configured to supply the motor with electric power used to operate the motor. This motor drive device includes an operation switch, a control unit, an adjusting unit, and a normal/reverse changeover switch. The operation switch is configured to be on/off-operated by a user of the motor-driven appliance. The control unit is configured to control a current flowing from the electric power source to the motor. The adjusting unit is configured to be operated by the user and to adjust a predetermined control target value used to control the motor. The normal/reverse changeover switch is configured to be operated by the user and to switch a rotational direction of the motor to either of a normal direction or a reverse direction. The control unit is further configured, in a case where the operation switch is in an on state, to control the current flowing to the motor based on the control target value adjusted by the adjusting unit when the rotational direction is set to the normal direction by the normal/reverse changeover switch; and to control the current flowing to the motor based on a preset fixed reverse rotation control target value used to reversely rotate the motor, regardless of the control target value set by the adjusting unit, when the rotational direction is set to the reverse direction by the normal/reverse changeover switch.

According to the thus-configured motor drive device, when the motor is normally rotated, the motor is driven by current control based on the control target value adjusted by the adjusting unit, whereas when the motor is reversely rotated, the motor is driven by current control based on the fixed reverse rotation control target value regardless of adjustment by the adjusting unit. Accordingly, by setting the reverse rotation control target value that enables the effective reverse rotation of the motor in the motor-driven appliance, the motor drive device can reversely rotate the motor effectively in the motor-driven appliance while reducing unnecessary power consumption.

An electric mowing machine according to another aspect of the present invention includes a mowing blade, a motor, an electric power source, an operation switch, a control unit, an adjusting unit, and a normal/reverse changeover switch. The motor is configured to rotationally drive the mowing blade. The electric power source is configured to supply the motor with electric power used to operate the motor. The operation switch is configured to be on/off-operated by a user of the electric mowing machine. The control unit is configured to control a current flowing from the electric power source to the motor. The adjusting unit is configured to be operated by the user and to adjust a predetermined control target value used to control the motor in either of a continuous manner and a stepwise manner. The normal/reverse changeover switch is configured to be operated by the user and to switch a rotational direction of the motor to either of a normal direction or a reverse direction. The control unit is further configured, in a case where the operation switch is in an on state, to control the current flowing to the motor based on the control target value adjusted by the adjusting unit when the rotational direction is set to the normal direction by the normal/reverse changeover switch; and to control the current flowing to the motor based on a preset fixed reverse rotation control target value used to reversely rotate the motor, regardless of the control target value set by the adjusting unit, when the rotational direction is set to the reverse direction by the normal/reverse changeover switch.

According to the thus-configured electric mowing machine, when the motor is normally rotated, current control based on the control target value adjusted by the adjusting unit is performed, whereas when the motor is reversely rotated, current control based on the fixed reverse rotation control target value is performed regardless of adjustment by the adjusting unit. Accordingly, when the motor is reversely rotated, it is possible to effectively remove grass entangled with the mowing blade while reducing unnecessary power consumption.

What should be specifically used as the above-described control target value can be considered variously, and a duty ratio may be used, for example. In this case, the control target value may be a target duty ratio, which is a target value of a duty ratio used to duty-ratio-control the current flowing to the motor. The control unit may be configured to duty-ratio-control the current flowing to the motor based on a preset fixed reverse rotation target duty ratio used to reversely rotate the motor, regardless of the target duty ratio set by the adjusting unit, when the rotational direction is set to the reverse direction by the normal/reverse changeover switch.

In this way, the current control at the time when the motor is reversely rotated can be simplified by controlling the current flow based on the fixed reverse rotation target duty ratio when the motor is reversely rotated.

As the control target value, a rotational speed may be used, for example. In this case, the electric mowing machine may include a rotational speed detection unit that is configured to detect the rotational speed of the motor. The control target value may be a target rotational speed, which is a target value of the rotational speed of the motor. The control unit may be configured, when the rotational direction is set to the reverse direction by the normal/reverse changeover switch, to feedback-control the current flowing to the motor such that the rotational speed detected by the rotational speed detection unit coincides with a preset fixed reverse rotation target rotational speed used to reversely rotate the motor regardless of the target rotational speed set by the adjusting unit.

In this way, by feedback-controlling the rotational speed of the motor such that the fixed reverse rotation target rotational speed is achieved when the motor is reversely rotated, the rotational speed of the motor is controlled to a constant speed regardless of changes in a load applied to the motor, and grass entangled with the mowing blade can be removed effectively.

As the motor and the electric power source, various types thereof can be used. For example, the motor may be a brushless motor and the electric power source may be a battery that is configured to output DC power. In this case, the electric mowing machine may include an inverter that has a plurality of semiconductor switching elements and is configured to convert the DC power outputted from the battery into three-phase alternating current (AC) power and to supply the three-phase AC power to the motor. The control unit may be configured to control the current flowing to the motor by individually controlling on/off of the plurality of semiconductor switching elements. The brushless motor is preferable as the motor used to drive the mowing blade in the electric mowing machine because the brushless motor is energy efficient, has a high power output, and further, is easy to maintain.

The control unit may be configured, when the rotational direction is set to the reverse direction by the normal/reverse changeover switch, to stop the current flowing to the motor even when the operation switch is in an on state, upon a lapse of a fixed period of time after the operation switch is turned on to start the current flowing to the motor based on the reverse rotation control target value.

### BRIEF DESCRIPTION OF THE DRAWINGS

The present invention will be described below by way of example with reference to accompanying drawings, in which:

FIG. 1 is a perspective view showing an entire structure of an electric mowing machine according to a first embodiment;

FIG. 2 is a block diagram showing an electrical configuration of the mowing machine;

FIG. 3 is a flowchart showing a motor control process;

FIG. 4 is a flowchart showing a normal/reverse switching lever detection process of S20 in the motor control process in FIG. 3;

FIG. 5 is a flowchart showing an output duty ratio setting process of S40 in the motor control process in FIG. 3;

FIG. 6 is a flowchart showing a motor drive time process of S50 in the motor control process in FIG. 3;

FIG. 7 is a flowchart showing a motor output process of S60 in the motor control process in FIG. 3; and

FIG. 8 is a flowchart showing a number-of-revolutions setting process according to a second embodiment.

### DETAILED DESCRIPTION OF THE PREFERRED EMBODIMENTS

### First Embodiment

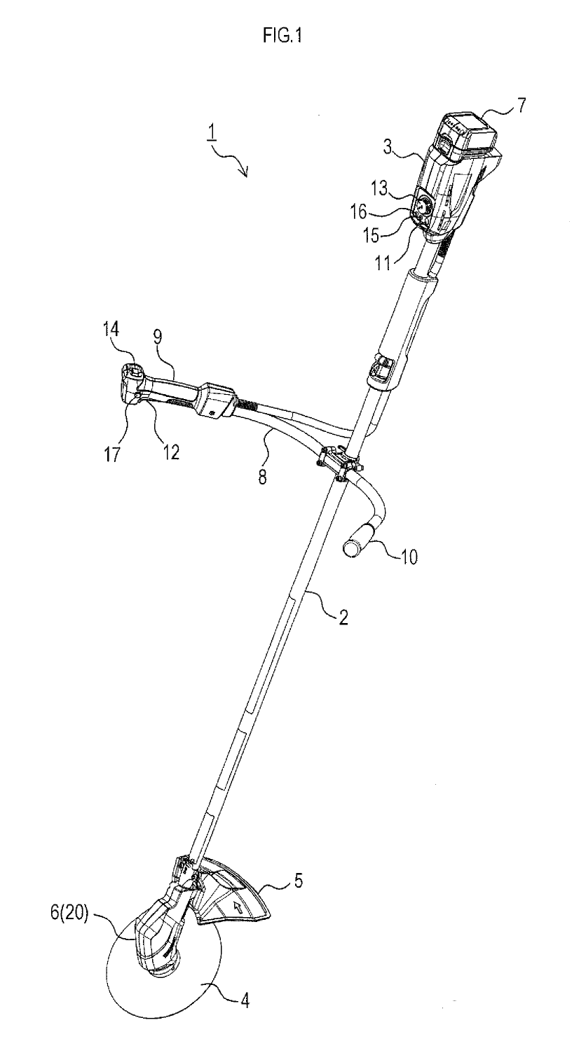

As shown in FIG. 1, a rechargeable electric mowing machine (hereinafter simply referred to as “mowing machine”) 1, which is a motor-driven appliance according to a present first embodiment, includes a shaft pipe 2, a control unit 3, a mowing blade 4, a motor unit 6, a battery 7, and a handle 8.

The shaft pipe 2 is formed in a hollow rod shape of a predetermined length. Provided on one end side of the shaft pipe 2 are the control unit 3 and the battery 7, and provided on the other end side of the shaft pipe 2 are the motor unit 6 and the mowing blade 4. On the other end side of the shaft pipe 2, a cover 5 is provided that suppresses grass and the like mowed with the mowing blade 4 from scattering toward a user of the mowing machine 1.

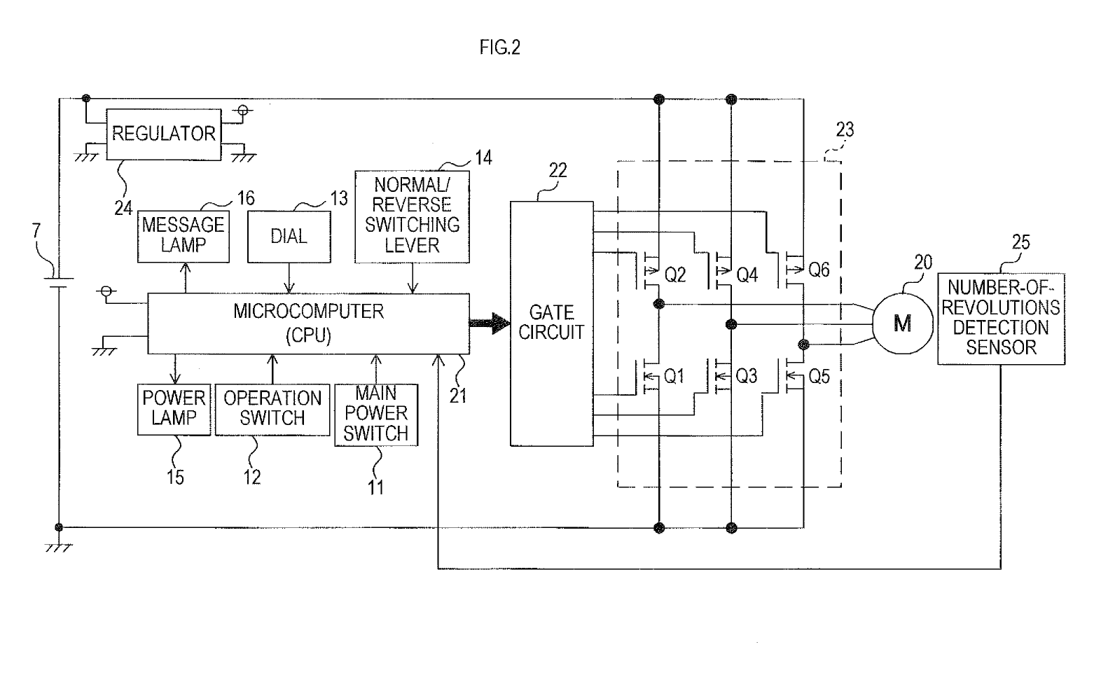

The motor unit 6 includes a motor 20 (see FIG. 2) that rotationally drives the mowing blade 4, a gear mechanism (illustration omitted) that transmits a rotation driving force of the motor 20 to the mowing blade 4, and the like. The motor 20 of the present first embodiment is a brushless motor.

The battery 7 is a repeatedly rechargeable power source that supplies electric power to the motor 20 and the control unit 3. The battery 7 of the present first embodiment is constituted by a lithium-ion rechargeable battery, which is only an example. A voltage of the battery 7 of the present first embodiment is 14.4 V or 18 V, for example, which is also only an example. The battery 7 is configured to be detachably attached to the control unit 3.

The control unit 3 is constituted by various electronic circuits and the like including a microcomputer 21 (see FIG. 2), which drive and control the motor 20. Housed inside the shaft pipe 2 are wirings that connect the control unit 3 and the motor unit 6 to each other.

The control unit 3 has a main power switch 11 and a dial 13 provided thereon in a manner operable by the user, and a power lamp 15 and a message lamp 16 provided thereon in a manner visually perceivable by the user.

The main power switch 11 is a switch that brings the mowing machine 1 into a usable state. When the user turns on the main power switch 11, DC power is supplied from the battery 7 to the control unit 3 to activate the control unit 3 (specifically, to activate the microcomputer 21), so that various controls by the microcomputer 21 are initiated. In short, by turning on the main power switch 11, mowing by the mowing machine 1 (i.e., rotary drive of the mowing blade 4) becomes enabled.

The power lamp 15 is a lamp that indicates whether or not the mowing machine 1 is in the usable state, and is constituted by an LED, for example. When the main power switch 11 is turned on to activate the microcomputer 21, the power lamp 15 is turned on by the microcomputer 21. When the microcomputer 21 stops operation, the power lamp 15 is turned off.

The message lamp 16 is a lamp that indicates a state of the battery 7, and is constituted by an LED, for example. Specifically, when the battery 7 is not in a normal state, that is, when the battery 7 is in an abnormal state, such as a state in which charge capacity of the battery 7 has been reduced; a state in which the battery 7 has reached a high temperature; and a state in which a discharge current from the battery 7 has become excessive (an overcurrent state), the microcomputer 21 causes the message lamp 16 to light up or flicker, whereby the abnormality state of the battery 7 is signaled.

The dial 13 is rotationally operated by the user in order to set a target duty ratio Dt, which is a target value of a drive duty ratio [%] at the time when the microcomputer 21 controls the motor 20. The target duty ratio Dt is set to a value corresponding to a position of the dial 13 (a position in a rotational direction). When the user rotates the dial 13, the target duty ratio Dt is changed in a continuous (non-stepwise) manner or in a stepwise manner within a predetermined adjustable range. The user can adjust the target duty ratio Dt with the dial 13 to a desired value within such an adjustable range.

The handle 8 is formed in U-shape, and is connected to the shaft pipe 2 at the vicinity of an intermediate position thereof in a length direction thereof. Provided on one end side (the left side in FIG. 1) and the other end side (the right side in FIG. 1) of both ends of the handle 8 are, respectively, a right-hand grip 9 to be grasped by the user with his right hand and a left-hand grip 10 to be grasped by the user with his left hand.

Provided on a leading end side of the right-hand grip 9 are an operation switch 12, a normal/reverse switching lever 14, and a lock-off switch 17, which are operated by the user.

The normal/reverse switching lever 14 is a switch that switches a rotational direction of the motor 20, that is, a rotational direction of the mowing blade 4, to either of a normal rotation and a reverse rotation. As the normal/reverse switching lever 14, a rocker switch is adopted, for example. When the user presses one side (the left side, for example) of the normal/reverse switching lever 14, the rotational direction of the mowing blade 4 is set to the normal rotation (a left-handed rotation, for example), whereas when the user presses the other side (the right side, for example) of the normal/reverse switching lever 14, the rotational direction of the mowing blade 4 is set to the reverse rotation (a right-handed rotation, for example).

The normal rotation is a rotational direction that should be set to when mowing grass, whereas the reverse rotation is a rotational direction that should be set to when removing grass entangled with the mowing blade 4.

The operation switch 12 is a switch that gives instructions to rotate or stop the mowing blade 4. When the user turns on the operation switch 12 (by pull-operating the operation switch 12 with his finger, for example) in a state where the microcomputer 21 is activated by turning on the main power switch 11, a current is supplied to the motor 20 at the target duty ratio Dt, which has been adjusted with the dial 13.

However, it is in a case where the rotational direction is set to the normal direction, that is, in a case where grass mowing is performed, that motor drive is performed at the target duty ratio Dt corresponding to a value adjusted with the dial 13. In a case where the rotational direction is set to the reverse direction, that is, in a case where the mowing blade 4 is reversely rotated to remove grass entangled with the mowing blade 4, in the present embodiment, the motor 20 is driven for a fixed period of specified reverse rotation time Tr at a preset fixed reverse rotation duty ratio Dr, which is used to reversely rotate the motor 20, regardless of the value adjusted with the dial 13. Upon lapse of the specified reverse rotation time Tr after initiation of the reverse rotation, the rotation of the motor 20 is stopped, even when the operation switch 12 is in an on state.

A reason why the duty ratio at the time of reverse rotation is set to the fixed reverse rotation duty ratio Dr and the time period for the reverse rotation is set to the fixed period of the specified reverse rotation time Tr is as follows. Specifically, assuming that the motor 20 is to be rotated at the target duty ratio Dt in accordance with the dial 13 even at the time of reverse rotation, if the dial 13 is set to a low level of the target duty ratio Dt at the time of reverse rotation, it might be impossible to successfully remove grass entangled with the mowing blade 4.

In contrast, if the dial 13 is set to a high level of the target duty ratio Dt at the time of reverse rotation, the motor 20 would be rotated at a high speed with a large driving force in accordance with the high target duty ratio Dt at the time of reverse rotation, too. Since the reverse rotation is intended to remove entangled grass, it is not surprising that a relatively small value (i.e., a value necessary and sufficient for removing the entangled grass) is sufficient as a driving force required at the time of reverse rotation. To rotate the mowing blade 4 with a large driving force similar to that at the time of normal rotation, at the time of reverse rotation not requiring such a large driving force, would lead to unnecessary consumption of electric power of the battery 7.

Moreover, if the number of revolutions at the time of reverse rotation is high, when applying for regulatory approval required for sales and the like of a product, the reverse rotation might not be determined to be an entanglement removal function (in other words, it might be considered that an operation equivalent to a regular mowing can be performed even at the time of reverse rotation) and thereby the regulatory approval might not be obtained, depending on the countries and/or regions where sales and the like of the product are to be performed.

It is user-friendly that the user can perform a driving force adjustment (a number-of-revolutions adjustment) in accordance with the dial 13 at the time of normal rotation, i.e., when mowing grass. However, when a driving force of the motor 20 at the time of reverse rotation for removing entangled grass is set to a fixed driving force suitable for removing entangled grass, such a setting is rather user-friendly, and is also preferable from the aspect of power consumption and application for regulatory approval. In addition, since the reverse rotation of the mowing blade 4 aims to remove entangled grass, the necessity of rotating the mowing blade 4 for a long period of time is low.

For these reasons, the mowing machine 1 of the present first embodiment is configured such that, at the time of reverse rotation, the motor 20 is driven at the fixed reverse rotation duty ratio Dr suitable for removing entangled grass regardless of the position of the dial 13, and such that the reverse rotation is stopped upon lapse of the fixed period of the specified reverse rotation time Tr after initiation of the reverse rotation regardless of a state of the operation switch 12.

As for a specific value of the reverse rotation duty ratio Dr, it would be adequate to decide the value theoretically or experimentally as appropriate taking into consideration, for example, a torque, the number of revolutions, and the like required for removing entangled grass. For example, assuming that a number of revolutions minimally required for removing entangled grass is referred to as a predetermined required minimum number of revolutions, the reverse rotation duty ratio Dr may be set to a value enabling rotation at least at the required minimum number of revolutions. Alternatively, for example, assuming that a torque minimally required when taking into consideration a load applied by grass entangled with the mowing blade 4 is referred to as a predetermined required minimum torque, the reverse rotation duty ratio Dr may be set to a value enabling rotation at a torque equal to or greater than the required minimum torque. Still alternatively, for example, in a case where, although it is possible to remove entangled grass at the required minimum number of revolutions (or the required minimum torque), it is preferable, and sufficient for grass removal, to reversely rotate the motor 20 at a number of revolutions (or a torque) greater than the required minimum number of revolutions (or the required minimum torque) by a predetermined amount (at 3,000 rpm, for example) when taking into consideration various changes of the condition during use such as a change in load or a change in battery voltage, a duty ratio enabling rotation of the motor 20 at such a number of revolutions (or at such a torque) may be set as the reverse rotation duty ratio Dr. Further alternatively, in a case where an upper limit of the number of revolutions for obtaining regulatory approval is set to a predetermined upper limit of the number of revolutions, a duty ratio enabling rotation of the motor 20 at a number of revolutions equal to or less than the upper limit of the number of revolutions may be set as the reverse rotation duty ratio Dr.

The operation switch 12 cannot be turned on unless the lock-off switch 17 is in a pressed state. The lock-off switch 17 is a push-button switch that suppresses an incorrect operation of the mowing blade 4. In a state in which the lock-off switch 17 is not pressed, movement of the operation switch 12 is regulated by a mechanical engagement of the lock-off switch 17 with the operation switch 12, and the operation switch 12 is thereby not turned on.

Next, an explanation will be given specifically about an electrical configuration and operation of the mowing machine 1 with reference to the block diagram of FIG. 2. As shown in FIG. 2, the mowing machine 1 includes the main power switch 11, the operation switch 12, the dial 13, the normal/reverse switching lever 14, the power lamp 15, the message lamp 16, and the microcomputer 21, which have already been described.

The mowing machine 1 further includes a gate circuit 22, an inverter 23, and a regulator 24. In the control unit 3 shown in FIG. 1, at least the microcomputer 21, the gate circuit 22, the inverter 23, and the regulator 24 are included.

The regulator 24 lowers a DC voltage of the battery and generates a control voltage having a predetermined DC voltage value. The control voltage generated by the regulator 24 is used as a power source for operation of the microcomputer 21, a power source for driving each of the lamps 15 and 16, and the like.

The microcomputer 21 is constituted by a CPU, various memories, an input/output interface, and the like. By the CPU's execution of various programs stored in the memories, various controls are performed in the microcomputer 21, such as a duty ratio control (Pulse Width Modulation control) of the motor 20 based on the value adjusted with the dial 13, a setting state of the normal/reverse switching lever 14, and the like, and a drive control of each of the lamps 15 and 16.

Although an illustration is omitted in FIG. 2, in a current-carrying path from the battery 7 to the regulator 24 and the inverter 23, a semiconductor switch is provided that blocks a current flowing from the battery 7 to the regulator 24 and the inverter 23. When the main power switch 11 is turned on while the semiconductor switch is in an off state, the semiconductor switch is turned on, and power supply to the regulator 24 is started to initiate operation of the microcomputer 21. During operation, the microcomputer 21 always maintains the semiconductor switch in an on state.

In a case where a given period of time has elapsed without any operation and the like by the user after initiation of operation of the microcomputer 21, the microcomputer 21 turns off the semiconductor switch on its own. In other words, the microcomputer 21 has a power-saving control function, in which the microcomputer 21 interrupts an electrical connection between the battery 7 and the control unit 3 to thereby stop discharge from the battery 7 when a non-use state of the mowing machine 1 continues for the given period of time. The above-described interruption of the electrical connection between the battery 7 and the control unit 3 as the power-saving control function is only an example. Other methods such as reduction of power consumption by shifting the microcomputer 21 into a sleep mode, for example, may be employed to achieve power saving.

After initiation of operation of the microcomputer 21 by turning-on of the main power switch 11, when the dial 13 is operated during the operation of the microcomputer 21, the microcomputer 21 sets the target duty ratio Dt in accordance with a operation state of the dial 13 (i.e., in accordance with the position of the dial 13). When the normal/reverse switching lever 14 is operated during the operation of the microcomputer 21, the microcomputer 21 sets the rotational direction in accordance with an operation state of the normal/reverse switching lever 14. When the operation switch 12 is turned on during the operation of the microcomputer 21, the microcomputer 21 calculates a control duty ratio Dc, which is a duty ratio for driving the motor 20, and outputs a control signal indicating the control duty ratio Dc to the gate circuit 22.

Although the target duty ratio Dt may be outputted as the control duty ratio Dc as it is, in the present first embodiment, the control duty ratio Dc is so designed as to reach the target duty ratio Dt eventually while being increased periodically by a predetermined amount (by a predetermined increment dc %, for example).

As has already been described, at the time of the reverse rotation of the motor 20, the control duty ratio Dc is controlled to the fixed reverse rotation duty ratio Dr. At the time of the reverse rotation of the motor 20 too, in the present first embodiment, the control duty ratio Dc is so designed as to reach the reverse rotation duty ratio Dr eventually while being increased periodically by a predetermined amount.

Besides, the microcomputer 21 has a protection function, in which the microcomputer 21 protects the control unit 3 when a temperature within the control unit 3 (for example, in the vicinity of the microcomputer 21 or in the vicinity of the inverter 23) becomes high. Specifically, the microcomputer 21 detects the temperature within the control unit 3 by means of a temperature detection element such as a thermistor (not shown) provided within the control unit 3, and when the detected temperature becomes equal to or higher than a predetermined temperature, the microcomputer 21 stops the motor 20 forcibly and causes the power lamp 15 to flicker.

When the main power switch 11 is turned on to initiate operation of the microcomputer 21, even when the operation switch 12 is turned on within a predetermined period of time after the initiation of the operation, the microcomputer 21 does not perform control and drive of the motor 20. Therefore, even if the user turns on the main power switch 11 while the operation switch 12 is in an on state, the motor 20 is not rotated although the microcomputer 21 starts operation and lights the power lamp 15. In this case, in order to rotate the motor 20, it is necessary for the user to once turn off the operation switch 12 and to turn on the operation switch 12 again.

As shown in FIG. 2, the inverter 23 is constituted as a three-phase bridge circuit including six semiconductor switching elements Q1, Q2, Q3, Q4, Q5, and Q6 (all MOSFETs in the present first embodiment). The inverter 23, constituted as the three-phase bridge circuit, converts DC power supplied from the battery 7 into a three-phase AC power and supplies the same to the motor 20.

Each of the semiconductor switching elements Q1 to Q6 in the inverter 23 is on/off driven by the gate circuit 22. The gate circuit 22 duty-drives (PWM-drives) each of the semiconductor switching elements Q1 to Q6 based on the control signal indicating the control duty ratio Dc inputted from the microcomputer 21. Therefore, as the control duty ratio Dc becomes larger, the current flowing in the motor 20 becomes greater; the rotation driving force of the motor 20 becomes greater; and the number of revolutions also becomes higher.

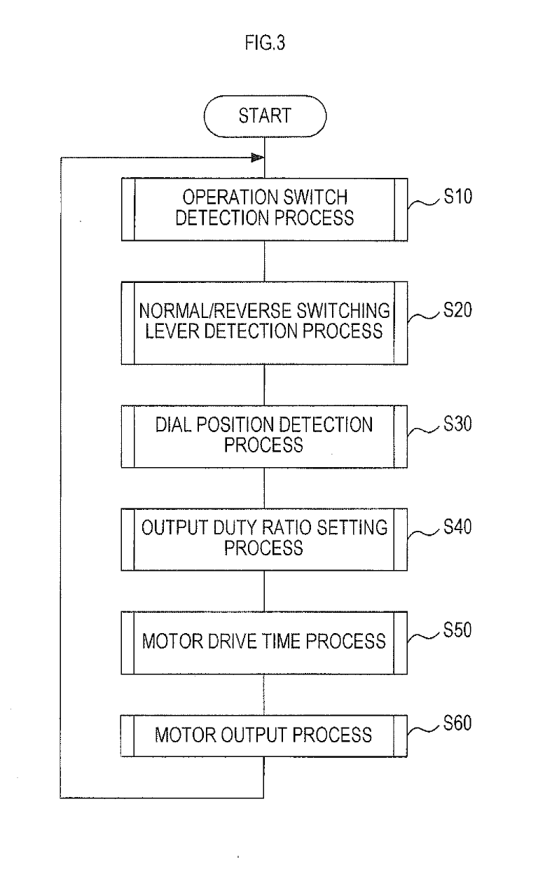

In the vicinity of the motor 20, a number-of-revolutions detection sensor 25 that detects the number of revolutions of the motor 20 is provided, and the detected value is inputted into the microcomputer 21. The number of revolutions of the motor 20 detected by the number-of-revolutions detection sensor 25 is used in a motor control process in FIG. 3, which will be described later. It is to be noted that the “number of revolutions” referred to herein means a number of revolutions per unit time (one minute, for example), i.e., a rotational speed.

Next, an explanation will be given about the motor control process executed by the microcomputer 21 with reference to FIG. 3 to FIG. 7. When the main power switch 11 is turned on to activate the microcomputer 21, the CPU in the microcomputer 21 loads a motor control process program (see FIG. 3) stored in the memory and starts the process. The motor control process in FIG. 3 is designed such that a series of processes from S10 to S60 is repeated as a whole at intervals determined in advance.

Upon starting the motor control process in FIG. 3, the CPU of the microcomputer 21 executes an operation switch detection process of S10. The operation switch detection process is a process that detects whether the operation switch 12 is in an on state or in an off state.

In S20, a normal/reverse switching lever detection process is executed. The normal/reverse switching lever detection process is a process that, when a switching operation of the normal/reverse switching lever 14 is performed during motor driving, sets a flag indicating such a performance of the switching operation; and that, when a switching operation of the normal/reverse switching lever 14 is performed in a state where the number of revolutions of the motor 20 is equal to or less than a predetermined reference low number of revolutions Nx, sets a flag indicating a rotational direction subsequent to such a switching operation.

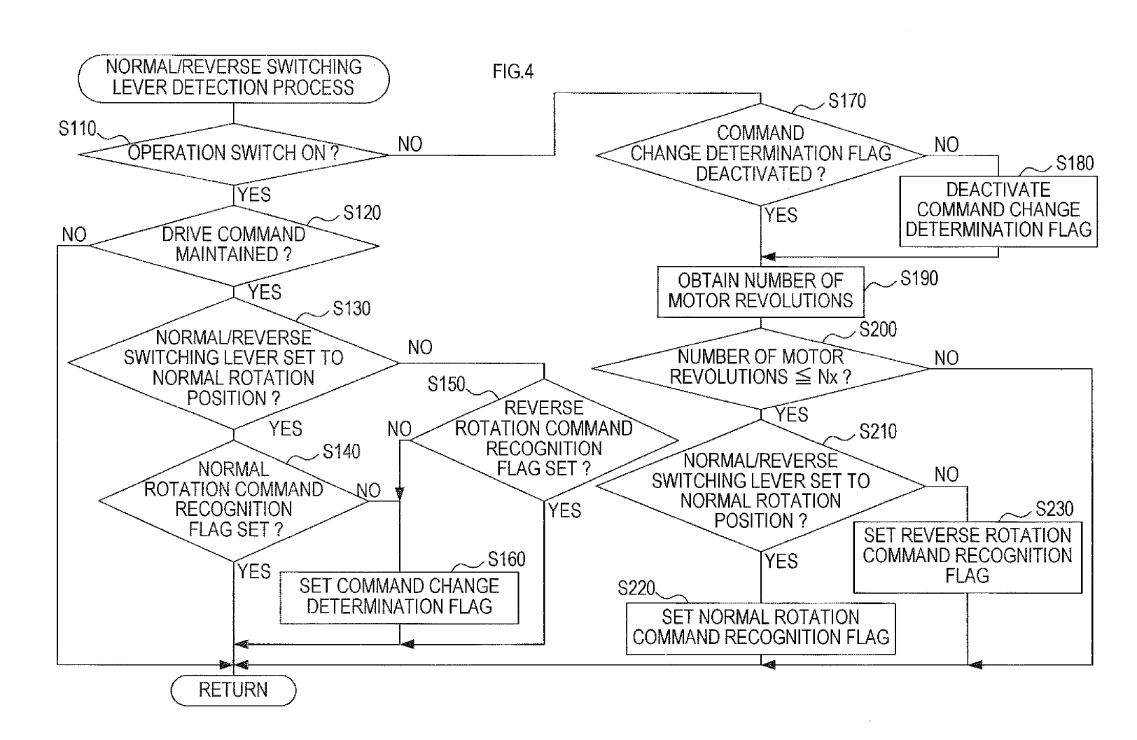

Details of the normal/reverse switching lever detection process of S20 are as shown in FIG. 4. When proceeding to the normal/reverse switching lever detection process shown in FIG. 4, the CPU determines in S110 whether or not the operation switch 12 is in an on state. When the operation switch 12 is in an on state, it is determined in S120 whether or not a command to drive the motor 20 (a drive command) is maintained, i.e., whether or not the output of the control signal indicating the control duty ratio Dc to the gate circuit 22 is maintained.

When the drive command is not maintained in S120, the normal/reverse switching lever detection process is terminated, and the process returns to the flow in FIG. 3 and proceeds to a dial position detection process of S30. When the drive command is maintained in S120, it is determined in S130 whether or not the normal/reverse switching lever 14 is set to a normal rotation position.

When it is determined in S130 that the normal/reverse switching lever 14 is set to the normal rotation position, it is determined in S140 whether or not a normal rotation command recognition flag is set. The normal rotation command recognition flag is a flag that indicates that the CPU has recognized that the normal/reverse switching lever 14 is set to the normal rotation position and is set in S220, which will be described later.

When the normal rotation command recognition flag is set in S140, the normal/reverse switching lever detection process is terminated, and the process proceeds to the dial position detection process of S30 (see FIG. 3). When the normal rotation command recognition flag is not set in S140, it is assumed that the normal/reverse switching lever 14 has been switched to be set to the normal rotation position during the reverse rotation of the motor 20. Therefore, in such a case, a command change determination flag is set in S160, and the normal/reverse switching lever detection process is terminated.

When it is determined in S130 that the normal/reverse switching lever 14 is not in the normal rotation position (i.e., is set to a reverse rotation position), it is determined in S150 whether or not a reverse rotation command recognition flag is set. The reverse rotation command recognition flag is a flag that indicates that the CPU has recognized that the normal/reverse switching lever 14 is set to the reverse rotation position and is set in S230, which will be described later.

When the reverse rotation command recognition flag is set in S150, the normal/reverse switching lever detection process is terminated, and the process proceeds to S30 (see FIG. 3). When the reverse rotation command recognition flag is not set in S150, it is assumed that the normal/reverse switching lever 14 has been switched to be set to the reverse rotation position during the normal rotation of the motor 20. Therefore, in such a case, the command change determination flag is set in S160, and the normal/reverse switching lever detection process is terminated.

When the operation switch 12 is in an off state in S110, it is determined in S170 whether or not the command change determination flag has been deactivated. When the command change determination flag has been deactivated, the process proceeds to S190, whereas when not, the command change determination flag is deactivated in S180, and the process proceeds to S190. In other words, even if the command change determination flag is set in S160 during rotation of the motor 20, this flag is deactivated when the operation switch 12 is turned off.

In S190, the number of revolutions of the motor 20 (hereinafter referred to as a number of motor revolutions) detected by the number-of-revolutions detection sensor 25 is obtained. In S200, it is determined whether or not the number of motor revolutions obtained in S190 is equal to or less than the predetermined reference low number of revolutions Nx. When the number of motor revolutions is greater than the reference low number of revolutions Nx, the normal/reverse switching lever detection process is terminated, and the process proceeds to S30 (see FIG. 3). When the number of motor revolutions is equal to or less than the reference low number of revolutions Nx, it is determined in S210 whether or not the normal/reverse switching lever 14 is set to the normal rotation position. When the normal/reverse switching lever 14 is set to the normal rotation position in S210, the normal rotation command recognition flag is set in S220, and the normal/reverse switching lever detection process is terminated to proceed to S30 (see FIG. 3). When the normal/reverse switching lever 14 is not set to the normal rotation position (i.e., is set to the reverse rotation position) in S210, the reverse rotation command recognition flag is set in S230, and the normal/reverse switching lever detection process is terminated to proceed to S30 (see FIG. 3).

In S30, the dial position detection process is executed. The dial position detection process is a process that detects a position of the dial 13 in the rotational direction. A detection result in the dial position detection process is used in an output duty ratio setting process of subsequent S40 in a case where the normal/reverse switching lever 14 is set to the normal rotation position.

In S40, the output duty ratio setting process is executed. This process is a process that sets a duty ratio of the control signal (the control duty ratio Dc) to be actually outputted to the gate circuit 22 in order to drive the motor 20.

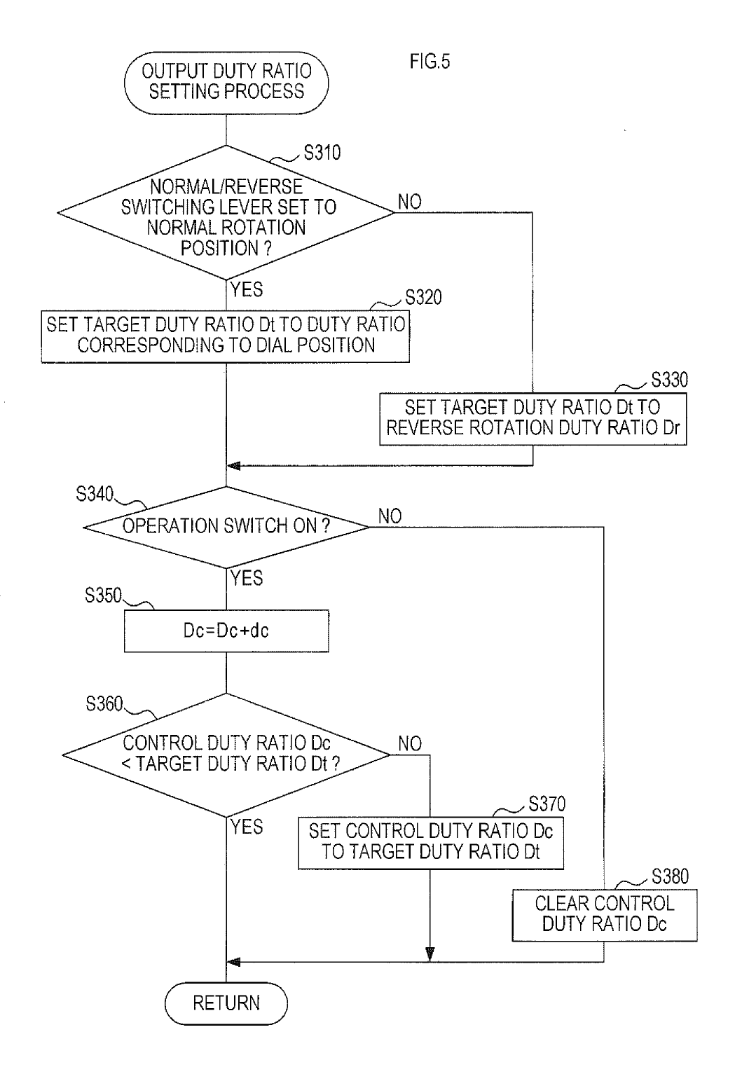

Details of the output duty ratio setting process of S40 are as shown in FIG. 5. When proceeding to the output duty ratio setting process shown in FIG. 5, the CPU determines in S310 whether or not the normal/reverse switching lever 14 is set to the normal rotation position.

When the normal/reverse switching lever 14 is set to the normal rotation position in S310, the target duty ratio Dt is set to a duty ratio corresponding to the position of the dial 13 in S320. When the normal/reverse switching lever 14 is set to the reverse rotation position in S310, the target duty ratio Dt is set to the fixed reverse rotation duty ratio Dr in S330. In other words, as has already been described, the target duty ratio Dt is set to the fixed reverse rotation duty ratio Dr during the reverse rotation regardless of the position of the dial 13.

In S340, it is determined whether or not the operation switch 12 is in an on state. When the operation switch 12 is in an off state in S340, the control duty ratio Dc is cleared to zero (0) in S380, and the output duty ratio setting process is terminated to proceed to S50 (see FIG. 3).

When the operation switch 12 is in an on state in S340, a value obtained by adding a predetermined rate of increase dc [%] to the current control duty ratio Dc is set as a new control duty ratio Dc in S350. In S360, it is determined whether or not the new control duty ratio Dc obtained by increasing by the rate of increase dc [%] is smaller than the target duty ratio Dt. When the new control duty ratio Dc is smaller than the target duty ratio Dt, the output duty ratio setting process is terminated immediately, and the process proceeds to S50 (see FIG. 3).

When it is determined in S360 that the control duty ratio Dc is equal to or greater than the target duty ratio Dt, the control duty ratio Dc is set as the target duty ratio Dt in S370. In this way, in the output duty ratio setting process, the control duty ratio Dc is set so as to reach the target duty ratio Dt eventually while being increased by the rate of increase dc [%] from an initial value (zero (0) in the present first embodiment). The target duty ratio Dt is a value corresponding to the position of the dial 13 during the normal rotation, and is the fixed reverse rotation duty ratio Dr independent of the dial 13 during the reverse rotation.

In S50, a motor drive time process is executed. This process is a process that mainly measures a drive time during the reverse rotation to thereby determine whether or not the specified reverse rotation time Tr has elapsed, and measures elapsed time from the turning-off of the operation switch 12.

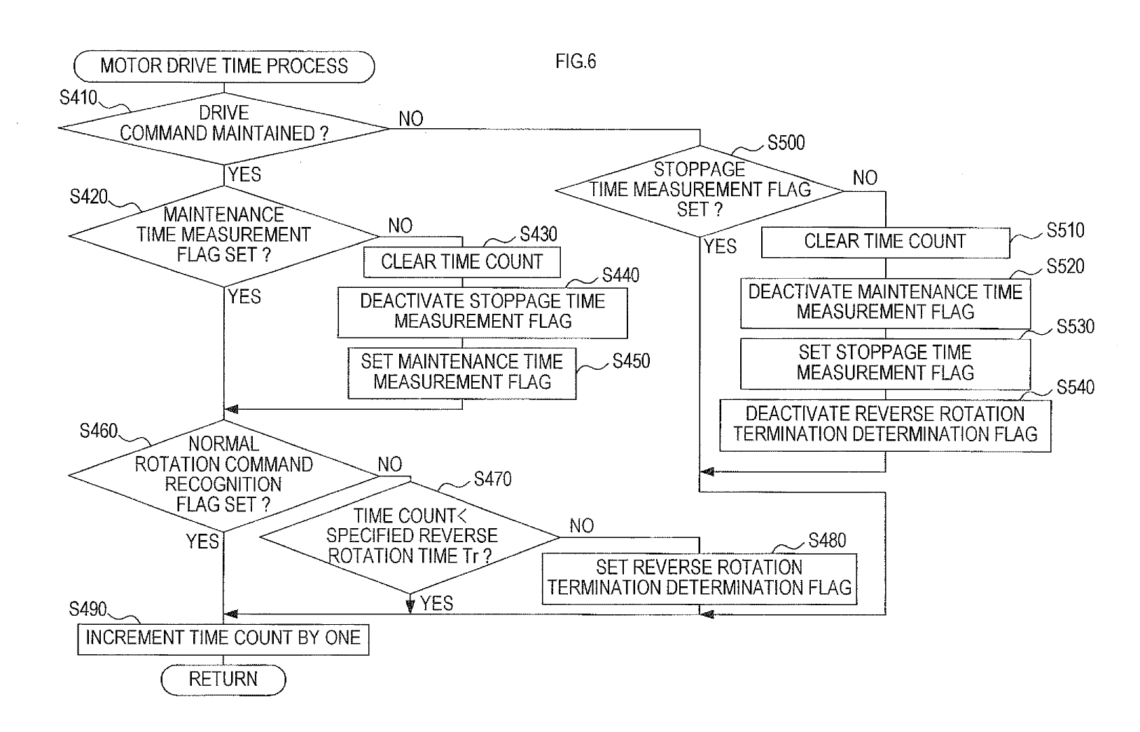

Details of the motor drive time process of S50 are as shown in FIG. 6. When proceeding to the motor drive time process shown in FIG. 6, the CPU determines in S410 whether or not the command to drive the motor 20 (the drive command) is maintained. When the drive command is maintained, it is determined in S420 whether or not a maintenance time measurement flag is set. This flag is a flag that indicates whether or not measurement of the maintenance time of the drive command is performed and is set in S450 or deactivated in S520.

When the maintenance time measurement flag is set in S420, the process proceeds to S460. When the maintenance time measurement flag is not set in S420, a time count is cleared in S430; a stoppage time measurement flag is deactivated in S440; the maintenance time measurement flag is set in S450; and the process proceeds to S460. The time count in S430 represents a value for timing counted by software.

In S460, it is determined whether or not the normal rotation command recognition flag (set in S220 in FIG. 4) is set. When the normal rotation command recognition flag is set, the time count is increased by one (I) (i.e., the value for timing is updated) in S490, and the motor drive time process is terminated to proceed to S60 (see FIG. 3).

When the normal rotation command recognition flag is not set (i.e., when the reverse rotation command recognition flag is set and the motor 20 is reversely rotated) in S460, it is determined in S470 whether or not the elapsed time indicated by the time count is shorter than the specified reverse rotation time Tr. When the elapsed time is shorter than the specified reverse rotation time Tr, the process proceeds to S490 and the timing is continued. In contrast, when the elapsed time is equal to or longer than the specified reverse rotation time Tr, a reverse rotation termination determination flag is set in S480, and the process proceeds to S490. In other words, it is designed such that while it is determined that the specified time has elapsed which should perform the reverse rotation, the timing itself is continued further.

When it is determined in S410 that the drive command is not maintained, it is determined in S500 whether or not the stoppage time measurement flag is set. This flag is a flag that indicates whether or not measurement of elapsed time after stoppage of the drive of the motor 20 is performed and is set in S530 or deactivated in S440.

When the stoppage time measurement flag is set in S500, the process proceeds to S490. When the stoppage time measurement flag is not set in S500, the time count is cleared in S510; the maintenance time measurement flag is deactivated in S520; the stoppage time measurement flag is set in S530; the reverse rotation termination determination flag is deactivated in S540; and the process proceeds to S490.

When the motor drive time process in FIG. 6 is terminated, the process proceeds to a motor output process of S60 (see FIG. 3). The motor output process of S60 is a process that mainly drives the motor 20 in accordance with the control duty ratio Dc when the operation switch 12 is in an on state and also during the normal rotation, whereas during the reverse rotation or after the operation switch 12 is turned off, in accordance with the elapsed time thereafter, performs free-run of the motor 20 (i.e., allows the motor 20 to rotate as-is due to inertia), a brake process and the like of the motor 20, to thereby stop the motor 20 eventually.

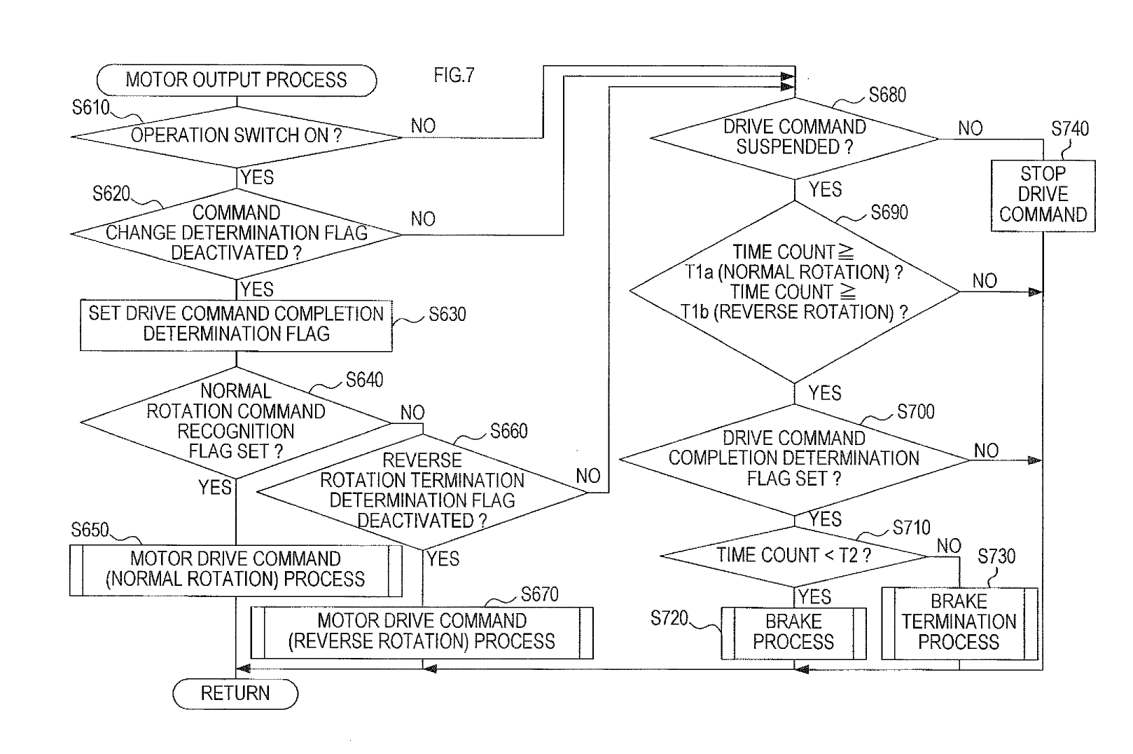

Details of the motor output process of S60 are as shown in FIG. 7. When proceeding to the motor output process shown in FIG. 7, the CPU determines in S610 whether or not the operation switch 12 is in an on state. When the operation switch 12 is in an on state, it is determined in S620 whether or not the command change determination flag (set in S160 and deactivated in S180 in FIG. 4) has been deactivated. When the command change determination flag has been deactivated, a drive command completion determination flag is set in S630, and the process proceeds to S640.

In S640, it is determined whether or not the normal rotation command recognition flag is set. When the normal rotation command recognition flag is set, a motor drive command (normal rotation) process is executed in S650. Specifically, by outputting the control signal indicating the currently-set control duty ratio Dc to the gate circuit 22, a motor drive (normal rotation) at the control duty ratio Dc is performed.

When it is determined in S640 that the normal rotation command recognition flag is not set, it is determined in S660 whether or not the reverse rotation termination determination flag has been deactivated. When the reverse rotation termination determination flag has been deactivated, a motor drive command (reverse rotation) process is executed in S670. Specifically, by outputting a control signal indicating the currently-set control duty ratio Dc (an eventual target is the reverse rotation duty ratio Dr) to the gate circuit 22, a motor drive (reverse rotation) at the control duty ratio Dc is performed.

When it is determine in S610 that the operation switch 12 is in an off state; when it is determined in S620 that the command change determination flag has not been deactivated; and when it is determined in S660 that the reverse rotation termination determination flag has not been deactivated, it is determined in S680 whether or not the drive command is suspended, i.e., whether or not the output of the control signal indicating the control duty ratio Dc to the gate circuit 22 is suspended. When the drive command is not suspended, the drive command is suspended in S740 by stopping the output of the control signal indicating the control duty ratio Dc. When the drive command has been already suspended, it is determined in S690 whether or not the elapsed time indicated by the time count is equal to or longer than a predetermined free-run setting time T1.

In the present first embodiment, a free-run setting time T1 (T1a) at the time of normal rotation and a free-run setting time T1 (T1b) at the time of reverse rotation are different from each other, and the free-run setting time T1b at the time of reverse rotation is shorter than the free-run setting time T1a at the time of normal rotation. In other words, the free-run of the motor 20 is designed to be terminated to shift to the brake process earlier at the time of reverse rotation than at the time of normal rotation. In the determination process of S690, a determination is made based on the free-run setting time T1a at the time of normal rotation, and a determination is made based on the free-run setting time T1b at the time of reverse rotation.

When the elapsed time indicated by the time count has not yet reached the free-run setting time T1 in S690, the motor output process is terminated. In contrast, when the elapsed time is equal to or longer than the free-run setting time T1, it is determined in S700 whether or not the drive command completion determination flag (set in S630) is set. When the drive command completion determination flag is not set, the motor output process is terminated. In contrast, when the drive command completion determination flag is set, it is determined in S710 whether or not the elapsed time indicated by the time count is shorter than a predetermined brake setting time T2.

In the present first embodiment, a value of the brake setting time T2 at the time of normal rotation and a value of the brake setting time T2 at the time of reverse rotation are the same as each other. However, these values may be different from each other.

When the elapsed time indicated by the time count is shorter than the brake setting time T2 in S710, the brake process is executed in S720, and the motor output process is terminated. As the brake process of S720, various methods can be adopted as long as braking of the motor 20 is possible. In the present first embodiment, a so-called short brake is adopted.

When the elapsed time indicated by the time count is equal to or longer than the brake setting time T2 in S710, a brake termination process is executed in S730, and the motor output process is terminated. The brake termination process of S730 terminates the brake process (the short brake in the present embodiment) and stops the motor drive completely (i.e., turns off all of the respective semiconductor switching elements Q1 to Q6 constituting the inverter 23).

According to the above-explained mowing machine 1 of the present first embodiment, a current control based on the target duty ratio Dt adjusted with the dial 13 is performed at the time of normal rotation, whereas at the time of reverse rotation, the fixed reverse rotation duty ratio Dr is set as the target duty ratio Dt regardless of the adjustment with the dial 13, and a current control is performed based on such a target duty ratio Dt. Accordingly, at the time of reverse rotation, it is possible to effectively remove grass entangled with the mowing blade 4 while reducing unnecessary power consumption.

In the present first embodiment, the mowing machine 1 corresponds to an example of an electric mowing machine of the present invention; the operation switch 12, the dial 13, the normal/reverse switching lever 14, the microcomputer 21, the gate circuit 22, and the inverter 23 correspond to an example of a motor drive device of the present invention; the microcomputer 21 corresponds to an example of a control unit of the present invention; the dial 13 corresponds to an example of an adjusting unit of the present invention; the normal/reverse switching lever 14 corresponds to an example of a normal/reverse changeover switch of the present invention; and the number-of-revolutions detection sensor 25 corresponds to an example of a rotational speed detection unit of the present invention.

### Second Embodiment

A present second embodiment is different from the first embodiment only in part. Therefore, only differences will be explained here.

In the above-described first embodiment, an explanation has been given with an example in which a control target value is a drive duty ratio. However, the control target value at the time of controlling the motor 20 may be other than the drive duty ratio. The mowing machine 1 in the present second embodiment is configured such that a target number of revolutions, which is a target value of a number of motor revolutions, can be adjusted with the dial 13 in a continuous (non-stepwise) manner or in a stepwise manner.

The microcomputer 21 feedback-controls (so-called speed-feedback-controls) the motor 20 in such a manner that the number of motor revolutions detected by the number-of-revolutions detection sensor 25 becomes the target number of revolutions. Specifically, when the rotational direction is set to the normal direction, the microcomputer 21 performs the feedback-control in accordance with the target number of revolutions adjusted with the dial 13, such that the number of motor revolutions coincides with the target number of revolutions. When the rotational direction is set to the reverse direction, the microcomputer 21 performs the feedback-control such that the number of motor revolutions coincides with a preset fixed reverse rotation target number of revolutions to be used to reversely rotate the motor 20 regardless of the target number of revolutions adjusted with the dial 13. The reverse rotation target number of revolutions is a predetermined number of revolutions within a range necessary and sufficient for removing grass and the like entangled with the mowing blade 4.

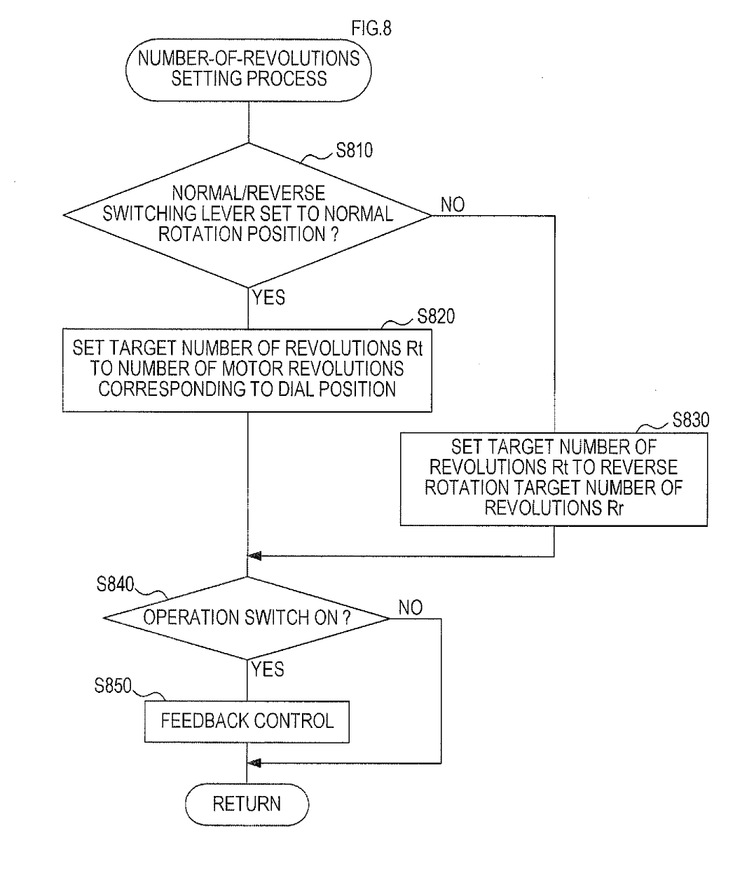

In order to achieve such an operation, the CPU of the microcomputer 21 in the present second embodiment executes, in the motor control process of S40 shown in FIG. 3, a number-of-revolutions setting process shown in FIG. 8, instead of the output duty ratio setting process.

When proceeding to the number-of-revolutions setting process shown in FIG. 8, the CPU determines in S810 whether or not the normal/reverse switching lever 14 is set to the normal rotation position.

When the normal/reverse switching lever 14 is set to the normal rotation position in S810, the target number of revolutions Rt is set to a number of motor revolutions corresponding to the position of the dial 13 in S820. When the normal/reverse switching lever 14 is set to the reverse rotation position in S810, the target number of revolutions Rt is set to a fixed reverse rotation target number of revolutions Rr in S830. In other words, as has already been described, at the time of reverse rotation, the target number of revolutions Rt is set to the fixed reverse rotation target number of revolutions Rr regardless of the position of the dial 13.

In S840, it is determined whether or not the operation switch 12 is in an on state. When the operation switch 12 is in an off state in S840, the number-of-revolutions setting process is terminated, and the process proceeds to S50 (see FIG. 3).

When the operation switch 12 is in an on state in S840, the number of revolutions of the motor 20 is feedback-controlled in S850, and the number-of-revolutions setting process is terminated to proceed to S50 (see FIG. 3). In S850, the following feedback-control is performed, for example. Specifically, the number of motor revolutions obtained in S190 and the target number of revolutions Rt are compared with each other. When the obtained number of motor revolutions is greater than the target number of revolutions Rt, the control duty ratio Dc is made to decrease, whereas when the obtained number of motor revolutions is smaller than the target number of revolutions Rt, the control duty ratio Dc is made to increase. By executing such a process, the number of motor revolutions is feedback-controlled such that the number of motor revolutions detected by the number-of-revolutions detection sensor 25 coincides with the target number of revolutions Rt.

As seen from the above, the mowing machine of the present second embodiment configured to control the motor 20 by the speed-feedback control can exhibit effects equivalent to those in the above-described first embodiment. A method of controlling the motor 20 by setting the target duty ratio as in the above-described first embodiment and a method of controlling the motor 20 by performing the speed-feedback-control as in the present second embodiment each have their own advantages. In the case of the first embodiment, since it is not necessary to perform various control computations such as a control computation based on a deviation between an actual number of revolutions and the target number of revolutions, there is an advantage that the control content can be simplified accordingly. In the case of the second embodiment, it is possible to control the number of revolutions to be constant regardless of various variable factors such as a change in the load applied to the motor 20 and a change in the remaining capacity of the battery 7, which affect the rotation of the motor 20. Thus, the second embodiment has an advantage that grass entangled with the mowing blade 4 can be effectively removed despite these various variable factors.

Although the embodiments of the present invention have been described so far, embodiments of the present invention are not limited to the above-described embodiments. It is needless to say that various modes can be employed as long as they belong to a technical scope of the present invention.

In the above-described embodiments, although explanations have been given taking as an example the case in which the motor 20 is a brushless motor and a power source of the motor 20 is the battery 7, which can be charged repeatedly, these are only examples. The present invention is also applicable to other motors than the brushless motor, and is also applicable to other power sources than the battery 7.

For example, the present invention is also applicable to an electric mowing machine including a DC brushed motor and various drive circuits (an H-bridge circuit, a half-bridge circuit, and the like, for example) that drives the DC brushed motor bi-directionally. As a power source, a primary (non-rechargeable) battery or an AC power source may be used, for example.

Although the present invention is applied to the mowing machine in the above-described embodiments, the present invention may be applied to other motor-driven appliances such as an electric power tool, for example.

Although various functions are achieved by the microcomputer 21 in the above-described embodiments, the functions achieved by the microcomputer 21 may be achieved by combinations of individual electronic components of various types; by an ASIC (Application Specified Integrated Circuit); by a programmable logic device such as an FPGA (Field Programmable Gate Array), for example; or by a combination of these.

What is claimed is:

1. An electric mowing machine comprising:
a mowing blade;
a motor configured to rotationally drive the mowing blade;
an electric power source configured to supply the motor with electric power used to operate the motor;
an operation switch configured to be on/off-operated by a user of the electric mowing machine;
a control unit configured to control a current flowing from the electric power source to the motor;
an adjusting unit configured to be operated by the user and to adjust a predetermined control target value used to control the motor in either of a continuous manner and a stepwise manner; and
a normal/reverse changeover switch configured to be operated by the user and to switch a rotational direction of the motor to either of a normal direction and a reverse direction,
wherein the control unit is further configured, in a case where the operation switch is in an on state, to control the current flowing to the motor based on the control target value adjusted by the adjusting unit when the rotational direction is set to the normal direction by the normal/reverse changeover switch; and to control the current flowing to the motor based on a preset fixed reverse rotation control target value used to reversely rotate the motor, regardless of the control target value set by the adjusting unit, when the rotational direction is set to the reverse direction by the normal/reverse changeover switch.

2. The electric mowing machine according to claim 1,
wherein the control target value is a target duty ratio, which is a target value of a duty ratio used to duty-ratio-control the current flowing to the motor, and
wherein the control unit is configured to duty-ratio-control the current flowing to the motor based on a preset fixed reverse rotation target duty ratio used to reversely rotate the motor, regardless of the target duty ratio set by the adjusting unit, when the rotational direction is set to the reverse direction by the normal/reverse changeover switch.

3. The electric mowing machine according to claim 1, the machine further comprising a rotational speed detection unit configured to detect a rotational speed of the motor,
wherein the control target value is a target rotational speed, which is a target value of the rotational speed of the motor, and
wherein the control unit is configured, when the rotational direction is set to the reverse direction by the normal/reverse changeover switch, to feedback-control the current flowing to the motor such that the rotational speed detected by the rotational speed detection unit coincides with a preset fixed reverse rotation target rotational speed used to reversely rotate the motor regardless of the target rotational speed set by the adjusting unit.

4. The electric mowing machine according to claim 1,
wherein the motor is a brushless motor,
wherein the electric power source is a battery configured to output direct current (DC) power,
wherein the electric mowing machine further comprises an inverter that includes a plurality of semiconductor switching elements and is configured to convert the DC power outputted from the battery into three-phase alternating current (AC) power and to supply the three-phase AC power to the motor, and
wherein the control unit is configured to control the current flowing to the motor by individually controlling on/off of the plurality of semiconductor switching elements.

5. The electric mowing machine according to claim 1,
wherein the control unit is configured, when the rotational direction is set to the reverse direction by the normal/reverse changeover switch, to stop the current flowing to the motor even when the operation switch is in an on state, upon a lapse of a fixed period of time after the operation switch is turned on to start the current flowing to the motor based on the reverse rotation control target value.
